(19) United States
(12) Patent Application Publication
(10) Pub. No.: US 2023/0357602 A1
(43) Pub. Date: Nov. 9, 2023

(54) EXTRUDABLE PRESSURE-SENSITIVE ADHESIVE

(71) Applicant: 3M INNOVATIVE PROPERTIES COMPANY, St. Paul, MN (US)

(72) Inventors: Mark E. NAPIERALA, St. Paul, MN (US); Thomas Q. CHASTEK, St. Paul, MN (US); Robert D. WAID, Maplewood, MN (US); Ross E. BEHLING, Woodbury, MN (US); Shaun M. WEST, St. Paul, MN (US); Jacob D. YOUNG, St. Paul, MN (US)

(21) Appl. No.: 17/425,880

(22) PCT Filed: Feb. 25, 2020
(86) PCT No.: PCT/IB2020/051604

§ 371 Date: Jul. 26, 2021

Related U.S. Application Data
(60) Provisional application No. 62/810,221, filed on Feb. 25, 2019.

(51) Int. Cl. C09J 7/38; C09J 7/35

(52) U.S. Cl. CPC C09J 7/381; C09J 7/35; C09J 2301/312; C09J 2301/50; C09J 2301/302; C09J 2301/304; C09J 2423/006; C09J 2400/243; C09J 2301/414

(57) ABSTRACT

Methods of bonding a pressure-sensitive adhesive to a substrate are provided. The methods include heating a styrenic block copolymer composition to provide an adhesive melt composition, wherein the styrenic block copolymer composition contains a hard segment block with a glass transition temperature of from 90° C. to 220° C.; masticating the adhesive melt composition; delivering the adhesive melt composition onto the substrate at a temperature that exceeds the glass transition temperature of the hard segment block by from 20° C. to 150° C.; and cooling the adhesive melt composition to obtain a bonded pressure-sensitive adhesive. Optionally, the substrate can be a non-film substrate, or the styrenic block copolymer composition can be provided in a core-sheath filament that includes a styrenic block copolymer core and a sheath that is non-tacky at ambient temperature.

### FIELD OF THE INVENTION

Provided are methods of bonding to substrates, along with related systems and assemblies. The provided methods can be particularly useful in bonding low-surface-energy substrates, porous substrates, and those with protruding or recessed surfaces.

### BACKGROUND

Pressure-sensitive adhesives are materials that adhere to a substrate upon application of pressure. They do not require solvent, water, or heat to provide an adhesive bond. These adhesives can provide very high bond strength and are capable of replacing traditional mechanical fasteners in many industrial applications. Manufacturers also appreciate these bonding solutions because they are economical and easy to use.

The automotive industry, for example, uses badges, emblems, body side moldings and trim components on each vehicle produced. Affixing these parts using pressure-sensitive adhesives has various advantages over the use of mechanical fasteners. Drilling of holes for mechanical fastening can lead to corrosion issues, especially in areas where there is water exposure. This issue is significantly reduced when using pressure-sensitive adhesives for these joinery applications. Further, these adhesives can hold parts clean to the bond line, provide a waterproof seal, and provide improved bond reliability.

### SUMMARY

Vehicle components have evolved as manufacturers continue to improve fuel efficiency and aesthetic appearance of its vehicles. A growing trend is toward the lightweighting of vehicles. This is often achieved by using low-density materials and thinner parts. Many modern trim components are no longer solid pieces, but hollowed out to thin wall stock. Reinforcing features such as ribs can be placed onto the backside of the parts to limit warpage and curvature of the part as it cools after injection molding. The bonding surfaces of these parts are often deeply recessed and can be difficult to bond using conventional adhesive tapes.

Another problem relates to the plastic, typically thermoplastic olefin (“TPO”), used to form these parts, which tend to have a low surface energy. As a result, common pressure-sensitive adhesives do not achieve a high degree of “wet out” on TPO and similar types of plastics, resulting in reduced surface area between the adhesive and the substrate. Primers and other surface treatments can be used to improve “wet out,” but these add to the complexity and cost of bonding. For these reasons, bonding to non-planar low-surface-energy substrates remains a challenging technical problem. Similar technical problems arise when bonding porous surfaces, including the surfaces of foams or non-woven materials, which can have difficulties forming a strong bond interface with pressure-sensitive adhesives.

Provided herein are bonding methods, systems, and assemblies that are suitable for use with a wide variety of substrates, including low-surface-energy substrates. In many cases, these substrates may be bonded as received, without need for priming. The pressure-sensitive adhesive is also extrudable, allowing it to be formed into shapes that conform to one or both bonding surfaces. For bonding discrete replicated parts, these methods can be easily customized for bonding to diverse geometries. From a sustainability viewpoint, these methods are also beneficial because they reduce adhesive waste in the manufacturing process.

In one aspect, a method of bonding a pressure-sensitive adhesive to a substrate is provided. The method comprises: heating a styrenic block copolymer composition to provide an adhesive melt composition, wherein the styrenic block copolymer composition contains a hard segment block with a glass transition temperature of from 90° C. to 220° C.; masticating the adhesive melt composition; delivering the adhesive melt composition onto the substrate at a temperature that exceeds the glass transition temperature of the hard segment block by from 20° C. to 150° C., wherein the substrate is a non-film substrate; and cooling the adhesive melt composition to obtain a bonded pressure-sensitive adhesive.

In a second aspect, a method of bonding a pressure-sensitive adhesive to a substrate is provided, the method comprising: heating a styrenic block copolymer composition to provide an adhesive melt composition, wherein the styrenic block copolymer composition contains a hard segment block with a glass transition temperature of from 90° C. to 220° C., the styrenic block copolymer composition being provided in a core-sheath filament comprising a styrenic block copolymer core and a sheath that is non-tacky at ambient temperature; masticating the adhesive melt composition; delivering the adhesive melt composition onto the substrate at a temperature that exceeds the glass transition temperature of the hard segment block by from 20° C. to 150° C.; and cooling the adhesive melt composition to obtain a bonded pressure-sensitive adhesive.

In a third aspect, a method of bonding a pressure-sensitive adhesive to a substrate is provided, the method comprising: heating a styrenic block copolymer composition to provide an adhesive melt composition, wherein the styrenic block copolymer composition contains a hard segment block with a glass transition temperature of from 90° C. to 220° C.; masticating the adhesive melt composition; delivering the adhesive melt composition onto the substrate at a temperature that exceeds the glass transition temperature of the hard segment block by from 20° C. to 150° C., wherein the substrate comprises a release surface; and cooling the adhesive melt composition to obtain a bonded pressure-sensitive adhesive.

In a fourth aspect, bonded assemblies made using the aforementioned methods are provided.

### BRIEF DESCRIPTION OF THE DRAWINGS

FIG. 1 is a schematic showing a method of bonding an adhesive to a substrate according to one exemplary embodiment.

FIG. 1A is a schematic showing a particular component used in the method of FIG. 1.

FIG. 2 is a perspective view of a filament adhesive that can be used with the method of FIG. 1.

FIG. 3 is a side cross-sectional view of a dispensing head capable of dispensing the filament adhesive of FIG. 2.

FIG. 4 is a perspective view of a dispensing system for the method of bonding of FIG. 1.

FIG. 5 is a perspective view of an exemplary substrate that shows its bonding surfaces.

FIG. 6 is a photograph of an automotive bracket bonded to an automotive glazing as viewed through the automotive glazing.

FIG. 7 is an exploded perspective view of an automotive headliner assembly, showing the automotive headliner, pressure-sensitive adhesive, and wire harness as separate layers.

Repeated use of reference characters in the specification and drawings is intended to represent the same or analogous features or elements of the disclosure. It should be understood that numerous other modifications and embodiments can be devised by those skilled in the art, which fall within the scope and spirit of the principles of the disclosure. The figures may not be drawn to scale.

### DEFINITIONS

As used herein:
“Ambient conditions” means at a temperature of 25 degrees Celsius and a pressure of 1 atmosphere (approximately 100 kilopascals).
“Ambient temperature” means at a temperature of 25 degrees Celsius.
“Glass transition temperature” means the temperature at which an amorphous polymer (or amorphous region of a semi-crystalline polymer) changes from a hard and relatively brittle state to a viscous or rubbery state as temperature is increased. As used herein, glass transition temperature is measured by Dynamic Mechanical Analysis as described in the examples.
“Low-surface-energy” means having a surface energy of from 20 mJ/m² to 37 mJ/m².
“Non-tacky” refers to a material that passes a “Self-Adhesion Test”, in which the force required to peel the material apart from itself is at or less than a predetermined maximum threshold amount, without fracturing the material. The Self-Adhesion Test is described in co-pending International Patent Application No. PCT/US19/17162 (Nyaribo et al.) and can be performed on a sample of the sheath material to determine whether or not the sheath is non-tacky.

### DETAILED DESCRIPTION

As used herein, the terms “preferred” and “preferably” refer to embodiments described herein that can afford certain benefits, under certain circumstances. However, other embodiments may also be preferred, under the same or other circumstances. Recitation of one or more preferred embodiments does not imply that other embodiments are not useful and is not intended to exclude other embodiments from the scope of the invention.

As used herein and in the appended claims, the singular forms “a,” “an,” and “the” include plural referents unless the context clearly dictates otherwise. Thus, for example, reference to “a” or “the” component may include one or more of the components and equivalents thereof known to those skilled in the art. Further, the term “and/or” means one or all of the listed elements or a combination of any two or more of the listed elements.

It is noted that the term “comprises” and variations thereof do not have a limiting meaning where these terms appear in the accompanying description. Moreover, “a,” “an,” “the,” “at least one,” and “one or more” are used interchangeably herein. Relative terms such as left, right, forward, rearward, top, bottom, side, upper, lower, horizontal, vertical, and the like may be used herein and, if so, are from the perspective observed in the particular drawing. These terms are used only to simplify the description, however, and not to limit the scope of the invention in any way.

Reference throughout this specification to “one embodiment,” “certain embodiments,” “one or more embodiments” or “an embodiment” means that a particular feature, structure, material, or characteristic described relating to the embodiment is included in at least one embodiment of the invention. Thus, the appearances of the phrases such as “in one or more embodiments,” “in certain embodiments,” “in one embodiment” or “in an embodiment” in various places throughout this specification are not necessarily referring to the same embodiment of the invention. Where applicable, trade designations are set out in all uppercase letters.

Methods described herein are directed to the bonding of adhesives, particularly pressure-sensitive adhesives, to one or more substrates. Substrates include articles intended to be permanently bonded to other articles, as might be encountered in industrial assemblies. Substrates also include articles with release surfaces, which are intended for temporary, releasable bonding.

As used herein, pressure-sensitive adhesives are materials that are normally tacky at room temperature and can be adhered to a surface by application of light finger pressure and thus may be distinguished from other types of adhesives that are not pressure-sensitive. A general description of pressure-sensitive adhesives may be found in the Encyclopedia of Polymer Science and Engineering, Vol. 13, Wiley-Interscience Publishers (New York, 1988). Additional description of pressure-sensitive adhesives may be found in the Encyclopedia of Polymer Science and Technology, Vol. 1, Interscience Publishers (New York, 1964). “Pressure sensitive adhesive” or “PSA”, as used herein, refers to a viscoelastic material that possesses the following properties: (1) aggressive and permanent tack, (2) adherence to a substrate other than a fluorothermoplastic film with no more than finger pressure, and (3) sufficient cohesive strength to cleanly release from the substrate. A pressure-sensitive adhesive may also meet the Dahlquist criterion described in Handbook of Pressure-Sensitive Adhesive Technology, D. Satas, 2^{nd} ed., page 172 (1989). This criterion defines a pressure-sensitive adhesive as one having a one-second creep compliance of greater than 1×10⁻⁶ cm²/dyne at its use temperature (for example, at temperatures in a range of from 15° C. to 35° C.).

In some embodiments, the pressure-sensitive adhesive has a composition that enables bonding to substrates that are ordinarily difficult to bond because of their surface chemistry, geometry, or both. For many applications, the provided methods provide superior bond performance on these substrates. These methods can also render unnecessary surface functionalization, cleaning, or prior application of a primer on these substrates. By enabling bondable articles to be used as received, these bonding methods can improve efficiency in the bonding process and save significant time and costs.

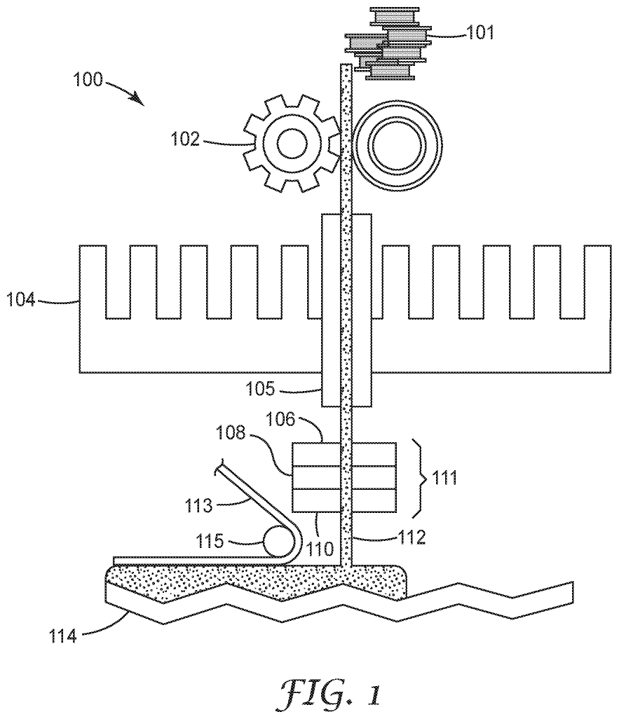

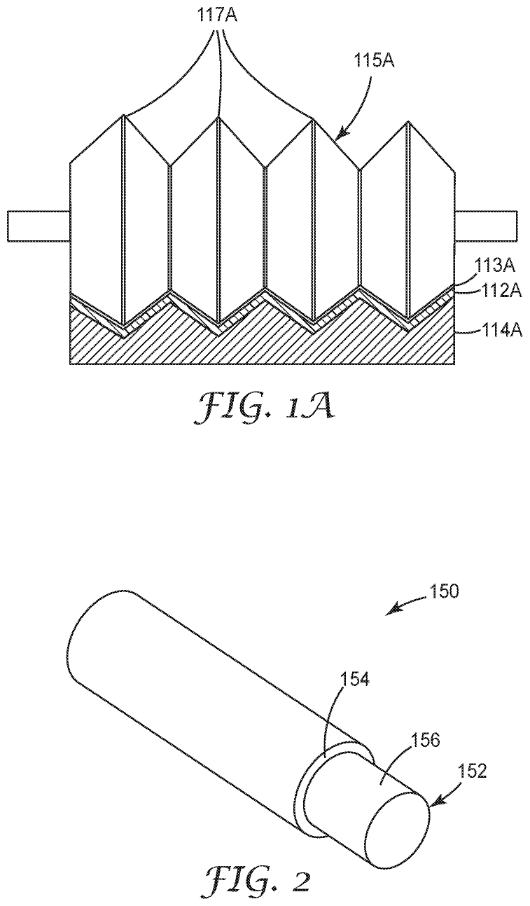

An exemplary process to bond an adhesive to a generic substrate 114 is shown schematically in FIG. 1 and herein referred by the numeral 100. In the process 100, a feed composition is conveyed through a feed mechanism 102, heat sink 104 coupled to a feedstock 105, and a mixer 111 comprised of a heater element 106, temperature sensor 108, and heater block hot end 110. Each of these is described in more detail below.

The feed mechanism 102 in FIG. 1 can be similar to that used in a fused deposition modeling (also sometimes referred to as fused filament fabrication) apparatus. In an exemplary embodiment, the feed mechanism 102 uses a drive gear which presses against an opposing bearing as shown. The teeth of the drive gear engage a solid feed composition, such as a spooled filament 101 as shown in FIG. 1, allowing it to grip and advance the feed composition into an extruder.

The feed compositions are not limited to any particular form—for example, a given adhesive component may also be provided in the form of a ribbon, pellets, flakes, or any other continuous or particulate form. For many applications, a filament form factor is preferred because it is easy to work with and its uniform cross-section enables precise metering of material by the feed mechanism 102.

The feed composition then passes through a heat sink 104. The heat sink 104 prevents heat from the heater element from being saturated through feedstock 105 back towards the feed mechanism 102. This causes the material to soften, making it difficult to push it into and through the mixer 111.

Within the mixer 111, the heater element 106 provides heat to the feed composition to provide an adhesive melt composition 112. Commonly, an electrical resistive heater is used in combination with a suitable temperature controller, which uses the temperature sensor 108 in a feedback loop to maintain a consistent operating temperature. The heater block hot end 110 provides a heated nozzle from which the adhesive melt composition 112 is dispensed through an outlet, or orifice. The size of the orifice in the heater block hot end 110 determines the size of the bead being dispensed. Orifice size, along with the feed rate, determines the volumetric output of the process 100.

In preferred embodiments, the heater element 106, temperature sensor 108, and heater block hot end 110 are integral components of the mixer 111, which masticates the feed composition 101 to obtain a homogenous and flowable melt. In preferred embodiments, the mixer 111 is a single- or twin-screw extruder. The rotating screw in an extruder can also assist in pulling the feed composition 101 through the feedstock 105. Alternatively, the mixer 111 could also be a dynamic or static mixer.

After being dispensed from the heater block hot end 110, the adhesive melt composition 112 is delivered to bonding surfaces of the substrate 114. When cooled to ambient temperature, the adhesive melt composition 112 provides a bonded pressure-sensitive adhesive.

The substrate 114 in FIG. 1 is generic. In some embodiments, the substrate 114 is a film substrate. Film substrates can be either continuous (e.g., a tape backing) or discontinuous (e.g., a decal). Film substrates can be made using a solvent casting, melt casting, or melt blown process and have a thickness, for example, of less than 0.254 millimeters (10 mil). Film substrates can have a generally uniform thickness. Alternatively, the substrate 114 is a non-film substrate such as a slab or molded part. Substrates may be rigid or flexible, and may have planar or non-planar bonding surfaces.

FIG. 1 further shows an optional step of continuously applying release liner 113 on top of the adhesive melt composition 112 soon after its delivery to the substrate 114. As will be described later, this can be used to prepare an adhesive pre-coated substrate for bonding to a second substrate at some later time. A roller 115 assists in pressing the release liner 113 onto the adhesive melt composition 112 and affords a generally flat surface contour as shown.

FIG. 1A shows an alternative embodiment of the roller 115 in FIG. 1. In this embodiment, the roller 115A (here, viewed from a direction rotated 90° from that shown in FIG. 1) has a plurality of ridges 117A that conform to an uneven surface of an underyling substrate 114A. This shaped roller 115A enables a suitable release liner 113A to be applied to an adhesive that tracks the uneven surface of the substrate 114A.

The feed composition used in the process 100 is preferably a block copolymer composition. Particularly preferred block copolymer compositions include styrenic block copolymer compositions. The styrenic block copolymer compositions generally include one or more styrenic block copolymers and one or more tackifiers. Tackifiers can be used to modify the glass transition temperature of either the hard segment block or soft segment block of the block copolymer composition.

Any number of styrenic block copolymers can be incorporated into this composition. One, two, three, four, or even more different styrenic block copolymers, inclusive of diblock, triblock, and star block copolymers, may be incorporated into this composition. In some embodiments, a suitable styrenic block copolymer comprises a copolymer of a (meth)acrylate with a styrene macromer. In select embodiments, the adhesive core can include a (meth)acrylic homopolymer.

Suitable tackifiers include rosins and their derivatives (including rosin esters); polyterpenes and aromatic-modified polyterpene resins; coumarone-indene resins; hydrocarbon resins, for example, alpha pinene-based resins, beta pinene-based resins, limonene-based resins, aliphatic hydrocarbon-based resins, aromatic-modified hydrocarbon-based resins; or combinations thereof. Non-hydrogenated tackifiers are typically more colorful and less durable (i.e., weatherable). Hydrogenated (either partially or completely) tackifiers may also be used. Examples of hydrogenated tackifiers include, for example: hydrogenated rosin esters, hydrogenated acids, hydrogenated aromatic hydrocarbon resins, hydrogenated aromatic-modified hydrocarbon-based resins, hydrogenated aliphatic hydrocarbon-based resins, or combinations thereof. Examples of synthetic tackifiers include: phenolic resins, terpene phenolic resins, poly-t-butyl styrene, acrylic resins, and combinations thereof.

Useful styrenic block copolymer compositions can have a hard segment block with a glass transition temperature of from 90° C. to 220° C., from 90° C. to 185° C., from 120° C. to 180° C., or in some embodiments, less than, equal to, or greater than 90° C., 95, 100, 105, 110, 115, 120, 125, 130, 135, 140, 145, 150, 155, 160, 165, 170, 175, 180, 185, 190, 195, 200, 205, 210, 215, or 220° C.

These styrenic block copolymer compositions are capable of being dispensed at high temperatures, allowing the adhesive melt composition to flow to a certain degree immediately after it is extruded. The adhesive melt composition can be delivered onto the substrate at a temperature that exceeds the glass transition temperature of the hard segment block by from 20° C. to 150° C., from 20° C. to 115° C., from 20° C. to 75° C., or in some embodiments, less than, equal to, or greater than 20° C., 25, 30, 35, 40, 45, 50, 55, 60, 65, 70, 75, 80, 85, 90, 95, 100, 105, 110, 115, 120, 125, 130, 135, 140, 145, or 150° C.

In some embodiments, the process 100 uses a single core-sheath filament 150 that consolidates the aforementioned feed composition components in a unitary form that is easily dispensed. In general, core-sheath filament materials have a configuration in which a first material (i.e., the core) surrounds a second material (i.e., the sheath), where the core and sheath share a common longitudinal axis. Preferably, the core and the sheath are concentric. The ends of the core need not be surrounded by the sheath.

FIG. 2 illustrates an exemplary core-sheath filament 150, which comprises an adhesive core 152 and a non-tacky sheath 154. As shown, the core 152 has a cylindrical outer surface 156 with the sheath 154 encircling the outer surface 156 of the core 152. The core-sheath filament 150 has a generally circular cross-section, but it is to be understood that other cross-sectional shapes (e.g., square, hexagonal, or multi-lobed shapes) are also possible. The non-tacky sheath 154 prevents the core-sheath filament 150 from sticking to itself. Conveniently, this allows the core-sheath filament 150 to be conveniently stored, transported, and unwound from a spool.

The diameter of the core-sheath filament is not particularly restricted. Factors that influence the choice of filament diameter include size constraints on the adhesive dispenser, desired adhesive throughput, and precision requirements for the adhesive application. The core-sheath filament can comprise an average diameter of 1 millimeter to 20 millimeters, 3 millimeters to 13 millimeters, 6 millimeters to 12 millimeters, or in some embodiments, less than, equal to, or greater than 1 millimeter, 2, 3, 4, 5, 6, 7, 8, 9, 10, 11, 12, 13, 14, 15, 16, 17, 18, 19, 20, 21, 22, 23, 24, 25, or 26 millimeters. The core-sheath filament 100 can be made in any length appropriate for the application.

Advantageously, the core-sheath filament 100 can retain a high melt viscosity when heated. This is desirable for dimensional stability of the dispensed adhesive on the substrate. Even when molten, these materials will not drip, sag or otherwise migrate from where they are disposed.

Core sheath filament adhesives according to the present disclosure can be made using any known method. In an exemplary embodiment, these filament adhesives are made by extruding molten polymers through a coaxial die. Further details, options and advantages concerning the aforementioned core sheath filament adhesives are described in co-pending International Patent Application No. PCT/US19/17162 (Nyaribo et al.).

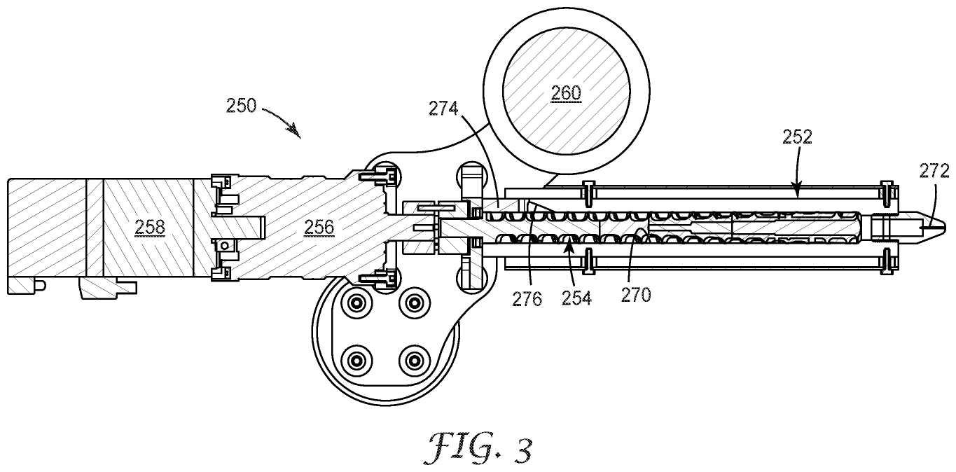

FIG. 3 shows a dispensing head 250 having a configuration capable of receiving, melting, mixing, and dispensing the core-sheath filament 150 of FIG. 2. The dispensing head 250 includes a barrel 252 and a rotatable screw 254 received therein. A gearbox 256 and motor 258 are operatively coupled to the screw 254. Optionally and as shown, an alignment wheel 260, which may be motorized, is affixed to a side of the barrel 252 through which filament is guided into the dispensing head 250. The roll of core-sheath filament 150 (not shown) can be continuously unwound during operation of the dispensing head 250.

The barrel 252 has the configuration of a barrel for a single screw extruder. The barrel 252 has an inner surface 270 that is cylindrical, engaging the screw 254 in an encircling relation. The inner surface 270 terminates in an outlet 272 at a distal end of the barrel 252. The outlet 272 can have any suitable shape. The barrel 252 further includes one or more embedded heating elements (not visible) for heating the inner surface 270 and melting the filament adhesive during a dispensing operation. Optionally, the inner surface 270 of the barrel 252 can be grooved or otherwise textured to increase friction between the barrel 252 and the extruded adhesive.

Referring again to FIG. 3, an inlet 274 extends through the top side of the barrel for receiving the filament adhesive. As further shown, the inlet 274 includes a beveled surface 276 defining a beveled nip point, where the beveled surface 276 converges with the outer surface of the screw 254. Advantageously, the beveled nip point prevents breakage of the filament adhesive as it is drawn into the barrel 252. The beveled nip point is part of a robust feed mechanism enabling the filament adhesive to be continuously fed into the barrel 252 without need for intervention by an operator.

The drive mechanism for the dispensing head 250 is provided by the gearbox 256 and motor 258. In some embodiments, the dispensing head 250 includes controls allowing for adjustment of the speed and/or torque of the rotating screw 254. In some embodiments, the motor 258 is a servo motor. Servo motors are advantageous because they can provide a high degree of torque over a wide range of rotational speed (rpm).

As shown, the inlet 274 has the shape of a reverse funnel, in which the transverse cross-sectional area of the inlet 274 becomes larger with increasing proximity to the screw 254. The inlet 274 has one or more sidewalls, such as front sidewall 276. The front sidewall 276 can be planar or curved. As viewed from a transverse direction, at least a portion of the front sidewall 276 extends at an acute angle relative to a longitudinal axis of the screw 254. The acute angle, which facilitates feeding of the filament adhesive, can be from 10 degrees to 70 degrees, from 18 degrees to 43 degrees, from 23 degrees to 33 degrees, or in some embodiments, less than, equal to, or greater than 10 degrees, 13, 15, 17, 20, 22, 25, 27, 30, 32, 35, 37, 40, 42, 45, 47, 50, 53, 55, 57, 60, 65, or 70 degrees.

Further details concerning the dispensing head 250 are described in co-pending U.S. Provisional Application No. 62/810,248 (Napierala et al.), filed on the same day as the present application.

The provided dispensing head offers many technical advantages. Its deployment in a dispensing system uses a spooled filament adhesive as a roll good, making loading and replacement of consumable materials easier, particularly in an automated process. The provided screw configurations are also well suited for use with PSA filament adhesives, which have a relatively soft viscoelastic consistency and are difficult to feed into conventional dispensers. Unlike conventional dispensers, the provided dispensing head does not require guide structures to feed the filament adhesive.

The provided dispensing head is also modular, enabling it to be used with any of various customized nozzles, providing a desired degree of precision in adhesive placement. The provided dispensing head can allow adhesive to be dispensed in a customized fashion. For example, it is possible to dispense an adhesive onto a substrate in a dot, stripe, or other discontinuous, pattern. Suitable coating patterns, as mentioned previously, need not be planar and can located on complex and irregular bonding surfaces.

It is also possible for the heated adhesive composition to be shaped as it is being delivered or cooled. Such shaping can be carried out by profile extrusion where the orifice of the outlet has a shape that is not conventional. The shape of the orifice may have, for instance, a curved or angled edge complemental to the corresponding bonding surface of the substrate.

As a further option, the adhesive composition can be molded by disposing the adhesive on a shaped release surface. After cooling, the molded pressure-sensitive adhesive can then be transferred from the release surface to a second substrate, to which it is permanently bonded. By molding the pressure-sensitive adhesive to a shape that is complemental to the second substrate, it is possible to improve adhesive coverage and reduce waste.

The provided dispensing head can be made highly efficient and lightweight. In some embodiments, the dispensing head has an overall weight that is at most 10 kg, at most 8 kg, or at most 6 kg. Working examples of the dispensing head are light and compact enough to be mounted to light duty robotic arms currently used in manufacturing facilities. Many robotic arms have weight limitations for dispense heads. A maximum weight limit for common robots is about 10 kg or less. Increasing the mass of the dispensing head can adversely impact its ability to rapidly move and accelerate within an automated adhesive dispensing process. Finally, since the screw and barrel are configured to provide excellent mixing within a short residence time in the melt zone, there is also reduced risk of thermal degradation of the adhesive.

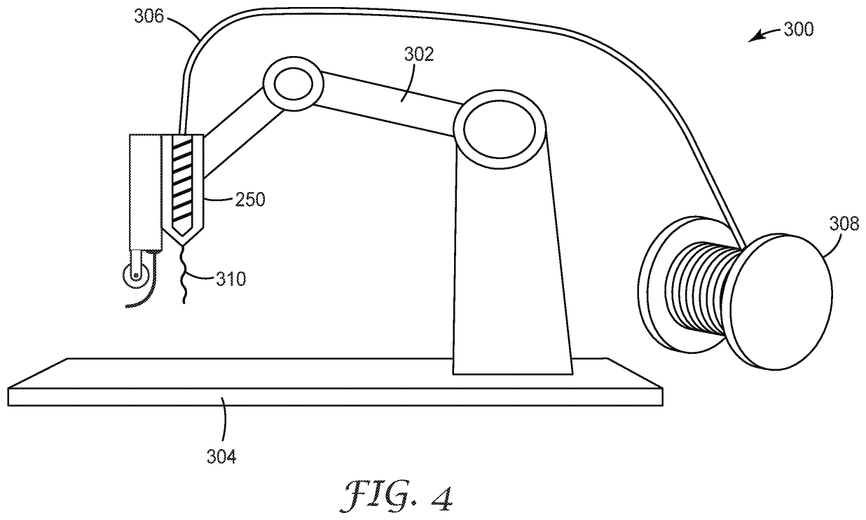

FIG. 4 illustrates a dispensing system 300 that includes the dispensing head 250 attached to the end of a movable arm 302. In some embodiments, the dispensing system 300 can be controlled by a computer, enabling the dispensing head 250 and movable arm 302 to be operated with a high degree of precision and repeatability within a manufacturing process.

The movable arm 302 is affixed to a table 304 and can have any number of robotic joints to provide a high degree of mobility. In some embodiments, the dispensing head 250 can be translated and rotated in up to six degrees of freedom. The movable arm 302 thus allows the dispensing head 250 to dispense an adhesive composition over a wide range of locations relative to the table 304. In some embodiments, the movable arm is part of a collaborative robot (or “cobot”) which has safety features allowing operators to work in close proximity to the robot without guarding in place.

Optionally and as shown, the dispensing system 300 includes a filament adhesive 306 for continuously feeding into the dispensing head 250 as shown in FIG. 4. The filament adhesive 306 can be continuously unwound from a spool 308 as shown. It is to be understood that the location of the spool 308 relative to other components of the dispensing system 300 is not critical and can be deployed where convenient. If desired, the spool 308 can be directly attached to the dispensing head 250. Alternatively, the spool 308 can be mounted to the movable arm 302, table 304, or any other structure thereon.

The dispensing head 250 is shown dispensing an adhesive composition 310 in hot melt form. The dispensing of the adhesive composition 310 can be automated or semi-automated, thus requiring little or no intervention by a human operator. One advantage of the provided methods is the possibility of dispensing the adhesive composition 310 onto a given substrate (such as the substrate 114 in FIG. 1) according to a pre-determined pattern. The pre-determined pattern can be two-dimensional (along a planar surface) or three-dimensional (along a non-planar surface). The pre-determined pattern can be represented by digital data on the computer, enabling the pre-determined pattern to be customized for any of a variety of different substrates.

In a preferred embodiment, the adhesive composition 310 is a thermoplastic elastomer that can continue to flow after it is dispensed. This can be a significant technical advantage when bonding to substrates with non-planar bonding surfaces. In certain applications, the adhesive melt can flow over protruding or recessed features of the substrate for increased mechanical retention. Optionally, the protruding or recessed features can have one or more undercuts to further enhance the strength of the bond.

FIG. 5 relates to an exemplary application for the dispensing system 300—bonding to a low-surface-energy substrate 350. The low-surface-energy substrate can be comprised of a polycrystalline polymer. The polycrystalline polymer can have a melting temperature of from 20° C. to 200° C., from 80° C. to 200° C., from 120° C. to 190° C., or in some embodiments, less than, equal to, or greater than 20° C., 25, 30, 35, 40, 45, 50, 55, 60, 65, 70, 75, 80, 85, 90, 95, 100, 110, 120, 130, 140, 150, 160, 170, 180, 190, or 200° C. The polycrystalline polymer can be, in some embodiments, a thermoplastic olefin or, more broadly, a polyolefin homopolymer or copolymer.

In this example, the substrate 350 has a cavity 352. Optionally, and as shown, the cavity 352 occupies most of the volume of the substrate 350, providing a hollow and lightweight construction. A plurality of ribs 354 extend into the cavity 352 to reinforce the structure and reduce any warpage that might occur after injection molding of the part.

In alternative embodiments, the substrate may have two or more cavities. The two or more cavities may or may not communicate with each other. The cavities may be of any suitable size, and may extend across any portion of the substrate. Although the ribs 354 shown in FIG. 5 only extend partially across the cavity 352, at least some of the ribs could fully traverse the cavity 352, if desired, to provide the substrate 350 with greater strength.

The size and shape of the ribs is not particularly limited and can be selected to balance the interests of lightweighting, ease of manufacture, and structural integrity within the constraints of a given application. It is notable that rib size and spacing is often constrained by design specifications, manufacturing considerations, or both. The provided bonding methods can enable strong adherence to these structures over wide ranges of rib dimensions.

The plurality of ribs can have an average thickness of from 0.5 millimeters to 2 millimeters, from 0.6 millimeters to 1.5 millimeters, from 0.7 millimeters to 1 millimeter, or in some embodiments, less than, equal to, or greater than 0.5 millimeters, 0.6, 0.7, 0.8, 0.9, 1, 1.1, 1.2, 1.3, 1.4, 1.5, 1.6, 1.7, 1.8, 1.9, or 2 millimeters. The plurality of ribs can have an average center-to-center spacing of from 0.5 millimeters to 8 millimeters, from 0.75 millimeters to 6 millimeters, from 2 millimeters to 4 millimeters, or in some embodiments, less than, equal to, or greater than 0.5 millimeters, 0.6, 0.7, 0.8, 0.9, 1, 1.2, 1.5, 1.7, 2, 2.2, 2.5, 2.7, 3, 3.5, 4, 4.5, 5, 5.5, 6, 6.5, 7, 7.5, or 8 millimeters.

Preferably, the adhesive composition flows and penetrates into spaces between the ribs 354. By providing an increased surface area for bonding, this configuration provides a significantly stronger bond compared with a planar bond configuration. Upon cooling, microphase separation of the adhesive composition provides cohesive strength and the material behaves as a pressure-sensitive adhesive. By comparison, conventional planar pressure-sensitive adhesives cannot adhere to recessed surfaces within the cavity 352, and thus tend to have lower bond strengths.

Using the provided bonding methods, with adhesive filling the spaces between the ribs 354 in the substrate 350, it is possible to obtain a 90° Peel Strength (as defined in the Examples) of from 10 N/cm to 100 N/cm, from 15 N/cm to 70 N/cm, from 20 N/cm to 55 N/cm, or in some embodiments, less than, equal to, or greater than 10 N/cm, 15, 20, 25, 30, 35, 40, 45, 50, 55, 60, 65, 70, 75, 80, 85, 90, 95, or 100 N/cm.

The adhesive-backed substrate may immediately be placed in contact with a corresponding article or assembly to provide a bonded assembly. If the adhesive-backed substrate is not ready to be bonded, exposed surfaces of the dispensed adhesive can be temporarily bonded to a release liner. Depending on the application, the adhesive-backed substrate can then be packaged and/or stored.

In some embodiments, the dispensing system includes a release liner, feed mechanism and, optionally, liner deposition equipment that may include a surface profiling feature (e.g., knife edge, roller, etc.). Soon after or contemporaneous with the adhesive being dispensed onto a surface of a given substrate (e.g., an exterior or interior trim part, or other article), a release liner can be placed on the applied adhesive and pressure applied above the liner to create a desired thickness of the applied adhesive and/or surface profile or topography on the outward-facing side of the applied adhesive. The adhesive can have a pre-determined thickness and/or pre-determined topography (e.g., a flat/uniform, textured or contoured surface). If desired, the thickness of the adhesive can be made intentionally non-uniform to correspond to an uneven substrate surface. Generally, the release liner can thus be useful to define a final adhesive surface profile, topography, and/or dimensions.

The release liner can also be useful in preventing dirt, dust and oxidation from affecting the adhesion and other properties of the applied adhesive. The liner can be easily peeled away from the applied adhesive at a later time. The release liner can have a width similar to that of the applied adhesive bead. Alternatively, use of a wider release liner can be advantageous in preventing or reducing the amount of adhesive squeezing out from under the release liner. The surface profile feature of the liner application tool can include a roller, knife edge or other structure used to press the liner onto the adhesive and/or profile the liner after it is applied. The liner application tool can have a straight, contoured, or otherwise profiled contacting edge that provides the desired profile/topography to the surface of the applied liner/adhesive.

In some embodiments, after the adhesive is dispensed on a corresponding substrate surface, it is allowed to cool to a temperature below its softening point and a release liner applied to the cooled adhesive. As used herein, the applied adhesive's softening point refers to the temperature at which the applied adhesive can be permanently deformed by the pressure used to apply the release liner. When at a temperature below its softening point, the adhesive dimension solely arises from the dispensing system. The release liner in this case does not necessarily need to be of a similar width to the adhesive bead. As before, the release liner could have a larger area than that of the applied adhesive (e.g., when the applied adhesive is in the form of a printed pattern, parallel lines, spiral lines, etc.), thereby allowing the liner to cover all of the adhesive printed. Optionally, the release liner could be reusable.

In some embodiments, the dispensing system deposits adhesive directly onto a release liner having an extended surface area. This could be some pattern of adhesive and the release liner is then used as a carrier to bring the adhesive in contact with the substrate. The release liner may include locating features that can be registered with the substrate to facilitate positioning of the adhesive. These steps could occur shortly after the adhesive cools and while it remains tacky. The release liner surface contacting the adhesive could also be textured or otherwise provided with useful topological features, described for example in U.S. Pat. Nos. 5,296,277 and 5,362,516 (both Wilson et al.); U.S. Pat. Nos. 5,141,790 and 5,897,930 (both Calhoun et al.); and U.S. Pat. No. 6,197,397 (Sher et. al) such as, for example, ridges or other structures that form air bleedable channels or other features into the adhesive at its interface with the liner.

In some embodiments, the adhesive is deposited between two release liners. For example, any of the aforementioned embodiments could be modified by substituting the substrate with a second release liner.

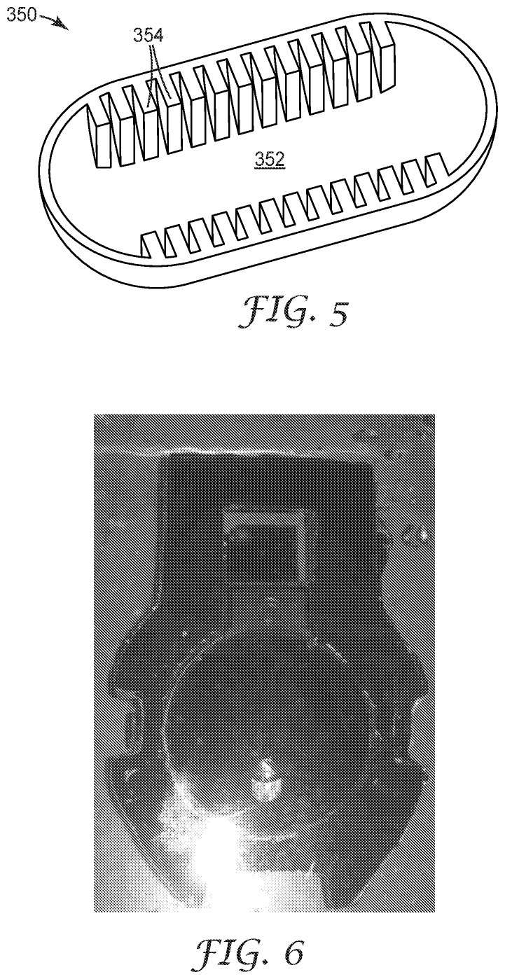

FIG. 6 shows the provided pressure-sensitive adhesive used in bonding to a smooth surface. Here, an attachment bracket is shown adhesively attached to an automotive glazing, or windshield. As shown, complete wet out was achieved between the glass and the bonding surfaces of the bracket.

Attachment brackets are commonly used for mounting an assortment of devices to the interior surfaces of automotive windshields. Such devices include mirrors, rain sensors, multifunctional cameras, collision avoidance sensors, which can be secured to a bonded bracket using clips or other mechanical fasteners. With attachments provided in different shapes and sizes, it is desirable to have a customized process where a controlled amount of adhesive is delivered to the bonding surfaces of the bracket, minimizing the amount of excess adhesive expressed beyond its peripheral edges.

In an exemplary embodiment, a computer guides a dispensing head to automatically dispense a pressure-sensitive adhesive onto the bonding surface of the attachment bracket, and the bracket/adhesive assembly subsequently mounted to the automotive glazing as shown in FIG. 6. Alternatively, the bracket/adhesive assembly may be placed on a release liner and mounted to the automotive glazing in a separate operation. The glazing is typically made from glass but can also be made from plastic materials such as polycarbonate or poly(meth)acrylate.

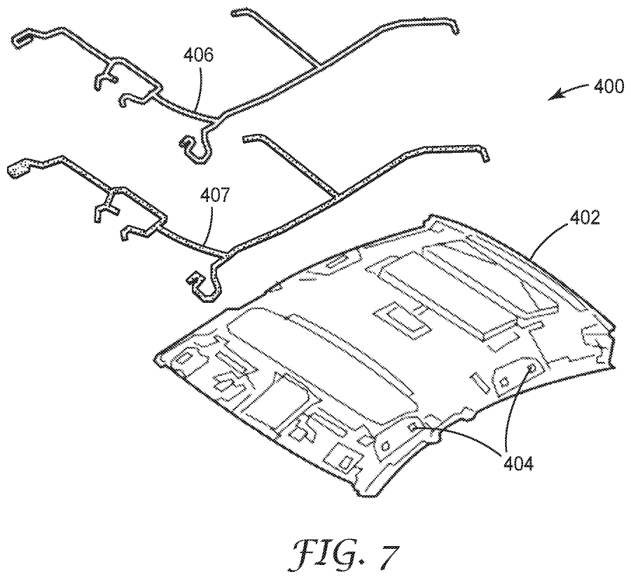

FIG. 7 shows application of a pressure-sensitive adhesive in an automotive headliner assembly 400. Headliners are composite materials adhered to the inside roof of an automobile or marine vehicle. In a typical construction, the headliner is comprised of a face fabric attached to a porous backing. Headliners visually soften the interior cabin, hide electronic wiring and air ducts, and can provide both acoustic and thermal insulation.

The headliner assembly 400 includes a one-piece headliner 402 that is contoured to fit the roof and side walls of a vehicle. To accommodate airflow vents and lighting components, through-holes 404 are provided in the headliner to receive these components. On the backside of the headliner 402 (the exposed surface in FIG. 7), a wire harness 406 is provided to communicate electronic signals and provide power. The wire harness 406 is affixed to the headliner 402 by a pressure-sensitive adhesive 407, which keeps the wire harness 406 in place and prevent rattles and shakes while the vehicle is being driven.

In some embodiments, the provided methods of bonding are used to secure the wire harness 406 to backside surfaces of the headliner 402. The provided pressure-sensitive adhesives enable the wire harness 406 to be at least partially embedded in the adhesive. This can be achieved at the point of use by delivering the adhesive to the wire harness 406 directly, or by initially delivering the adhesive to the headliner 402 then subsequently pressing the wire harness 406 into the adhesive with the application of heat. In either case, the pressure-sensitive adhesive is disposed only where it is needed and can be easily customized for any number of headliner and wire harness configurations.

The porous backing of the headliner 402 is not particularly limited. In some embodiments, it is comprised of a thermoplastic foam. The thermoplastic foam may be made from polystyrene, polyurethane, styrene-maleic anhydride polymer, styrene-acrylonitrile polymer, or copolymer or blend thereof.

Foams may be prepared using any known method, including by inclusion of a physical blowing agent, chemical blowing agent, or a hollow filler such as hollow glass bubbles. Useful physical blowing agents include expandable microspheres used for making closed-cell foams, such as those available under the trade designations DUALITE from Chase Corporation, Westwood, MA, United States and EXPANCEL from Nouryon, Amsterdam, The Netherlands.

In other embodiments, the porous backing is made from a fibrous substrate, such as a non-woven material comprised of a plurality of polymeric fibers. The non-woven material may be made by either a melt blown or spun bond process, and contain fibers made from nylon, acrylic, polyester, polypropylene, or a combination thereof.

To further enhance bond performance, it can be especially advantageous to apply the provided bonding methods to a heated or even molten substrate. If the adhesive melt comes into contact with a molten substrate, entanglement of the polymeric chains can occur at the interface, strengthening the bond interface. Notably, it was discovered that this can be effective for low-surface energy substrates.

In some embodiments, a low-surface-energy substrate is extruded in molten form while delivering the adhesive melt composition onto the low-surface-energy substrate, wherein the molten low-surface-energy substrate is at a temperature of from 150° C. to 260° C., from 160° C. to 250° C., from 170° C. to 220° C., or in some embodiments, less than, equal to, or greater than 150° C., 155, 160, 165, 170, 175, 180, 185, 190, 195, 200, 205, 210, 215, 220, 225, 230, 235, 240, 245, 250, 255, or 260° C. when it comes into contact with the adhesive melt composition. The adhesive melt composition and molten substrate may be extruded from two separate dies or co-extruded from the same die.

The low-surface-energy substrate may be comprised of any of the suitable materials previously identified. The low-surface-energy substrate is made from a glassy thermoplastic, a thermoplastic elastomer, or even a crosslinked rubber.

While not intended to be limiting, exemplary embodiments of the provided bonding methods and assemblies are listed below:
1. A method of bonding a pressure-sensitive adhesive to a substrate, the method comprising: heating a styrenic block copolymer composition to provide an adhesive melt composition, wherein the styrenic block copolymer composition contains a hard segment block with a glass transition temperature of from 90° C. to 220° C.; masticating the adhesive melt composition; delivering the adhesive melt composition onto the substrate at a temperature that exceeds the glass transition temperature of the hard segment block by from 20° C. to 150° C., wherein the substrate is a non-film substrate; and cooling the adhesive melt composition to obtain a bonded pressure-sensitive adhesive.
2. The method of embodiment 1, wherein the styrenic block copolymer composition is provided in a core-sheath filament comprising a styrenic block copolymer core and a sheath that is non-tacky at ambient temperature.
3. A method of bonding a pressure-sensitive adhesive to a substrate, the method comprising: heating a styrenic block copolymer composition to provide an adhesive melt composition, wherein the styrenic block copolymer composition contains a hard segment block with a glass transition temperature of from 90° C. to 220° C., the styrenic block copolymer composition being provided in a core-sheath filament comprising a styrenic block copolymer core and a sheath that is non-tacky at ambient temperature; masticating the adhesive melt composition; delivering the adhesive melt composition onto the substrate at a temperature that exceeds the glass transition temperature of the hard segment block by from 20° C. to 150° C.; and cooling the adhesive melt composition to obtain a bonded pressure-sensitive adhesive.
4. The method of embodiment 3, wherein the substrate is a non-film substrate.
5. The method of any one of embodiments 1-4, wherein the hard segment block has a glass transition temperature of from 90° C. to 185° C.
6. The method of embodiment 5, wherein the hard segment block has a glass transition temperature of from 120° C. to 180° C.
7. The method of any one of embodiments 1-6, wherein the styrenic block copolymer composition comprises one or more tackifiers.
8. The method of any one of embodiments 1-7, wherein the adhesive melt composition is delivered at a temperature that is from 20° C. to 115° C. above the glass transition temperature of the hard segment block.
9. The method of embodiment 8, wherein the adhesive melt composition is delivered at a temperature that is from 20° C. to 75° C. above the glass transition temperature of the hard segment block.
10. The method of any one of embodiments 1-9, wherein the bonded pressure-sensitive adhesive has a density of from 0.5 g/cm³ to 2 g/cm³.
11. The method of embodiment 10, wherein the bonded pressure-sensitive adhesive has a density of from 0.6 g/cm³ to 1.1 g/cm³.
12. The method of embodiment 11, wherein the bonded pressure-sensitive adhesive has a density of from 0.8 g/cm³ to 1 g/cm³.
13. The method of any one of embodiments 1-12, wherein the adhesive melt composition is foamed when delivered onto the substrate.
14. The method of embodiment 13, wherein the adhesive melt composition comprises a physical blowing agent.
15. The method of embodiment 13, wherein the adhesive melt composition comprises a chemical blowing agent.
16. The method of embodiment 13, wherein the adhesive melt composition comprises hollow glass bubbles.
17. The method of any one of embodiments 2-16, wherein the sheath comprises a styrenic block copolymer, polyolefin, ethylene acrylate copolymer, ethylene vinyl acetate, polyurethane, styrene butadiene copolymer, or blend or copolymer thereof
18. The method of embodiment 2-17, wherein the sheath and core are homogenously mixed with each other as the adhesive melt composition is masticated.
19. The method of any one of embodiments 2-18, wherein the core-sheath filament is delivered by a dispensing head comprising: a barrel including one or more heating elements; an inlet extending through a side of the barrel for receiving the core-sheath filament, the inlet including a beveled nip point to prevent breakage of the core-sheath filament as it is drawn into the barrel; an outlet at a distal end of the barrel for dispensing the adhesive melt composition; and a rotatable screw received in the barrel, the rotatable screw including at least one mixing element to masticate the adhesive melt composition.
20. The method of any one of embodiments 1-19, wherein the substrate has a bonding surface that is non-planar.
21. The method of embodiment 20, wherein the substrate comprises one or more cavities, and wherein the adhesive melt composition upon delivery at least partially fills the one or more cavities.
22. The method of embodiment 21, wherein the substrate further comprises a plurality of ribs extending across the one or more cavities and wherein the adhesive melt composition upon delivery at least partially fills spaces between the plurality of ribs.
23. The method of embodiment 22, wherein the plurality of ribs have an average thickness of from 0.5 millimeters to 2 millimeters.
24. The method of embodiment 23, wherein the plurality of ribs have an average thickness of from 0.6 millimeters to 1.5 millimeters.
25. The method of embodiment 24, wherein the plurality of ribs have an average thickness of from 0.7 millimeters to 1.0 millimeters.
26. The method of any one of embodiments 22-25, wherein the plurality of ribs have an average center-to-center spacing of from 0.5 millimeters to 8 millimeters.
27. The method of embodiment 26, wherein the plurality of ribs have an average center-to-center spacing of from 0.75 millimeters to 6 millimeters.
28. The method of embodiment 27, wherein the plurality of ribs have an average center-to-center spacing of from 2 millimeters to 4 millimeters.
29. The method of any one of embodiments 22-28, wherein the bonded pressure-sensitive adhesive displays a 90° Peel Strength of from 10 N/cm to 100 N/cm.
30. The method of embodiment 29, wherein the bonded pressure-sensitive adhesive displays a 90° Peel Strength of from 15 N/cm to 70 N/cm.
31. The method of embodiment 30, wherein the bonded pressure-sensitive adhesive displays a 90° Peel Strength of from 20 N/cm to 55 N/cm.
32. The method of any one of embodiments 1-31, wherein the substrate comprises a low-surface-energy substrate having a surface energy of from 20 mJ/m² to 37 mJ/m².
33. The method of embodiment 32, wherein the low-surface-energy substrate comprises a thermoplastic olefin.
34. The method of embodiment 33, wherein the thermoplastic olefin comprises a thermoplastic elastomer.
35. The method of embodiment 34, wherein the thermoplastic elastomer comprises ethylene-propylene-diene-monomer (EPDM) rubber.
36. The method of any one of embodiments 32-35, wherein the low-surface-energy substrate comprises a polycrystalline polymer, the polycrystalline polymer having a melting temperature of from 20° C. to 200° C.
37. The method of embodiment 36, wherein the polycrystalline polymer has a melting temperature of from 80° C. to 200° C.
38. The method of embodiment 37, wherein the polycrystalline polymer has a melting temperature of from 120° C. to 190° C.
39. The method of any one of embodiments 32-38, wherein the low-surface-energy substrate is unprimed.
40. The method of embodiment 39, wherein the low-surface-energy substrate is not surface-treated or cleaned prior to delivering the adhesive melt composition.
41. The method of any one of embodiments 32-38, further comprising extruding the low-surface-energy substrate in molten form while delivering the adhesive melt composition onto the low-surface-energy substrate, wherein the low-surface-energy substrate in molten form is at a temperature of from 150° C. to 260° C. when contacting the adhesive melt composition.
42. The method of embodiment 41, wherein the low-surface-energy substrate in molten form is at a temperature of from 160° C. to 250° C. as it contacts the adhesive melt composition.
43. The method of embodiment 42, wherein the low-surface-energy substrate in molten form is at a temperature of from 170° C. to 220° C. as it contacts the adhesive melt composition.
44. The method of any one of embodiments 41-43, wherein the low-surface-energy substrate comprises a crosslinked rubber.
45. The method of any one of embodiments 1-44, wherein the substrate comprises glass or ceramic enamel.
46. The method of any one of embodiments 1-44, wherein the substrate is an attachment bracket for an automotive glazing.
47. The method of embodiment 46, further comprising placing the bonded pressure-sensitive adhesive in contact with the automotive glazing to secure the attachment bracket to the automotive glazing.
48. The method of embodiment 47, wherein the automotive glazing comprises glass.
49. The method of any one of embodiments 1-44, wherein the substrate comprises a porous substrate.
50. The method of embodiment 49, wherein the porous substrate comprises a thermoplastic foam.
51. The method of embodiment 50, wherein the thermoplastic foam comprises polystyrene, polyurethane, styrene-maleic anhydride polymer, styrene-acrylonitrile polymer, or copolymer or blend thereof.
52. The method of embodiment 51, wherein the porous substrate comprises a fibrous substrate.
53. The method of embodiment 52, wherein the fibrous substrate comprises a plurality of polymeric fibers.
54. The method of embodiment 53, wherein the plurality of polymeric fibers comprise nylon, acrylic, polyester, polypropylene, or combination thereof.
55. The method of any one of embodiments 49-54, wherein the porous substrate is part of an automotive headliner.
56. The method of embodiment 55, further comprising placing an electrical wire harness in contact with the bonded pressure-sensitive adhesive.
57. The method of embodiment 56, further comprising at least partially embedding the electrical wire harness in the adhesive melt composition.
58. The method of any one of embodiments 1-57, wherein the adhesive melt composition is shaped as it is being delivered or cooled.
59. The method of embodiment 58, wherein the adhesive melt composition is shaped by profile extrusion.
60. The method of embodiment 58, wherein the adhesive melt composition is shaped by molding against a release surface disposed on the substrate.
61. The method of embodiment 60, wherein the substrate is a first substrate, and further comprising transferring the bonded pressure-sensitive adhesive from the first substrate to a second substrate.
62. The method of embodiment 61, wherein the bonded pressure-sensitive adhesive has a shape complemental to that of the second substrate.
63. A method of bonding a pressure-sensitive adhesive to a substrate, the method comprising: heating a styrenic block copolymer composition to provide an adhesive melt composition, wherein the styrenic block copolymer composition contains a hard segment block with a glass transition temperature of from 90° C. to 220° C.; masticating the adhesive melt composition; delivering the adhesive melt composition onto the substrate at a temperature that exceeds the glass transition temperature of the hard segment block by from 20° C. to 150° C., wherein the substrate comprises a release surface; and cooling the adhesive melt composition to obtain a bonded pressure-sensitive adhesive.
64. The method of embodiment 63, wherein the substrate is a release liner.
65. The method of embodiment 64, wherein the substrate is a first substrate and further comprising transferring the bonded pressure-sensitive adhesive from the first substrate to a second substrate.
66. A bonded assembly made using the method of any one of embodiments 1-65.

### EXAMPLES

Objects and advantages of this disclosure are further illustrated by the following non-limiting examples, but the particular materials and amounts thereof recited in these examples, as well as other conditions and details, should not be construed to unduly limit this disclosure.

Unless otherwise noted, all parts, percentages, ratios, etc. in the Examples and the rest of the specification are by weight.

TABLE 1
Materials

| Designation | Description | Source |
|---|---|---|
| 45/45/10 | Poly(isooctyl acrylate-co-butyl acrylate- | 3M Company, St. |
| | co-acrylic acid) | Paul. MN. United |
| | | States |
| 3794 | Thermoplastic high tack pressure | 3M Company, St. |
| | sensitive adhesive available under the | Paul. MN. United |
| | trade designation 3M HIGH TACK | States |
| | PRESSURE SENSITIVE ADHESIVE | |
| | 3794 | |
| 5074 | Double-sided 2.0 mm acrylic sealing | 3M Company, St. |
| | tape available under the trade | Paul. MN. United |
| | designation 3M WIRE HARNESS | States |
| | TAPE 5074 | |
| 6111T | Sprayable Hot Melt adhesive, polyolefin | 3M Company, St. |
| | copolymer thermoplastic | Paul. MN. United |
| | | States |
| CB Pellets | A pelletized ethyl vinyl acetate | Clariant |
| | containing carbon black at a con- | Corporation, |
| | centration of 40 wt %, available under | Holden, MA |
| | the trade designation REMAFIN | |
| | BLACK EVA 40% | |
| D1113 | A styrene-isoprene-styrene triblock | Kraton |
| | copolymer having an approximate | Performance |
| | styrene under the trade designation | Polymers, Houston, |
| | KRATON D1113 | TX. United States |
| D1161P | A styrene-isoprene-styrene triblock | Kraton |
| | copolymer having an approximate | Performance |
| | styrene content of 15% and 19% di- | Polymers, Houston, |
| | block content, available under the trade | TX. United States |
| | designation KRATON D1161P | |
| D1340 | A styrene-isoprene-styrene mutli-arm | Kraton |
| | star block copolymer available under the | Performance |
| | trade designation KRATON D1340 | Polymers, Houston, |
| | | TX. United States |
| DK11 | A styrene-butadiene copolymer available | Ineos Styrolution, |
| | under the trade designation K-RESIN | Aurora, IL. United |
| | DK11 | States |
| EPDM | Ethylene propylene diene terpolymer. | Cooper, New |
| | ASTM D2000-00 BLACK 70 | Philadelphia, OH. |
| | DUROMETER EPDM 1.313″ w × | United States |
| | 0.125″ THICK RECTANGLE | |
| | 1026987-00 | |
| EX4011 | Double-sided adhesive 1.14 mm acrylic | 3M Company, St. |
| | foam core tape available under the trade | Paul. MN. United |
| | designation 3M ACRYLIC PLUS | States |
| | TAPE EX4011 | |
| HTG1 | Poly(isobornyl-co-acrylic acid) polymer | 3M Company, St. |
| | (described in Table 1 of commonly | Paul. MN. United |
| | owned PCT Patent Publication No. | States |
| | WO 2018/116067) | |
| I1010 | Pentaerythritoltetrakis(3-(3,5-ditertbutyl- | BASF Corporation, |
| | 4-hydroxyphenyl)propionate) available | Florham Park, NJ. |
| | under the trade designation | United States |
| | IRGANOX 1010 | |
| LBR-361 | Polybutadiene homopolymer available | Kuraray, Houston, |
| | under the designation LBR-361 | TX. United States |
| LDPE | A low-density polyethylene resin | Lyondell Basell, |
| | available under the trade designation | Houston, TX. |
| | PETROTHENE NA217000 | United States |
| NEVTAC | Low T_{g} aliphatic tackifier available | Neville Chemical |
| LT | under the trade designation NEVTAC | Company, |
| | LT | Pittsburgh, PA. |
| | | United States |
| P125 | A fully hydrogenated hydrocarbon | Arakawa Chemical, |
| | resin, available under the trade | Chicago, IL. |
| | designation ARKON P-125 | United States |
| P140 | A fully hydrogenated hydrocarbon | Arakawa Chemical, |
| | resin, available under the trade | Chicago, IL. |
| | designation ARKON P-140 | United States |
| P1500 | Partially hydrogenated styrenic block | Asahi Kasei |
| | copolymer available under the trade | Corporation, |
| | designation TUFTEC P1500 | Tokyo, Japan |
| PT1100 | Double-sided adhesive 1.14 mm acrylic | 3M Company, St. |
| | foam core tape available under the trade | Paul, MN. United |
| | designation 3M ACRYLIC PLUS | States |
| | TAPE PT1100 | |
| SA90 | Dual hydroxyl-end functional | Sabic Americas, |
| | polyphenylene ether oligomer available | Houston, TX. |
| | under the trade designation NORYL | United States |
| | SA90 | |

### Test Methods

90° Peel Strength Test Method: The test standard followed was ASTM D6862, with minor modification at ambient conditions. A substrate was cut into 1.59 cm×16.5 cm (0.63 inch×6.5 inch) strips, to which half of the substrate had a thin film of Adhesion Promoter 4298UV (3M Company, St. Paul, MN. United States) applied using a sponged tip application tool. For testing to EPDM, clear coats and a ribbed LSE plastic adhesive samples disposed between two release liners were cut into 1.27 cm×12.7 cm (0.5 inch×5.0 inch strips) and then laminated to both the coated with adhesion promoter and uncoated substrates using a rubber roller with only hand pressure. Samples were aged to the substrate in a force air oven for five minutes at 190° C. and allowed to cool to room temperature for at least 30 minutes before the release liner was removed. They were laminated to a 0.81 mm (32 mil) thick aluminum (Al) panel or an automotive paint panel RK8211 (ACT Test Panels of Hillsdale, MI. United States) with a rubber roller with hand pressure and then samples were compressed with a 4.54 kg (10 lb.) roller using four total passes over the adhesive. For testing to a ribbed LSE substrate and headliner materials, adhesive was extruded directly onto the substrates. A thin (10 mil) Al ribbon 0.75″ wide and 6″ long was placed on the adhesive and manually rolled down with a rubber roller using hand pressure. Sample testing was conducted on a 3300 Universal Testing System load frame equipped with a 50 kilonewton load cell (Instron, Norwood, MA. United States). Samples were clamped into the load frame with the free end of the substrate in the top clamp and the panel the adhesive was stuck to was placed in a fixture that maintained a 90° angle during peel. The sample was peeled at 30.5 cm/min (12 in/min). Samples were stretched for 117 mm of head movement. The first 25 mm of peel data was discarded and the average peel force over the next 89 mm was recorded. Unless otherwise noted, the sample was laminated to anodized aluminum as the second substrate.

T-Peel Test Method: The test standard followed was ASTM D1876, with minor modification. Adhesive disposed between two release liners was cut into 2.54 cm×17. cm (1 inch×7 inch) strips then laminated to a 3.18 cm×22.9 cm (1.25 inch×9 inch) strip of a substrate with a rubber roller using only hand pressure. The release liner was removed and a second strip of a substrate was applied to the top of the adhesive with a rubber roller. Samples were then aged in a force air oven for five minutes at 190° C. Immediately upon removal from the oven, samples were manually compressed with a 4.54 kg (10 lb.) roller using four total passes over the adhesive. Samples were allowed to cool for at least 30 minutes prior to testing on the 3300 Universal Testing System load frame equipped with a 50 kilonewton load cell (Instron, Norwood, MA. United States). Samples were clamped into the load frame with the free end of the substrate in a T-Peel configuration and peeled at 30.5 cm/min (12 in/min). Samples were stretched for 225 mm of head movement. The first 50 mm of peel data was discarded and the average peel force over the next 175 mm was recorded.

Dynamic Mechanical Analysis Test Method: The examples were analyzed by Dynamic Mechanical Analysis (DMA) using a DHR-3 parallel plate rheometer (TA Instruments, New Castle, DE. United States) to characterize the physical properties of each sample as a function of temperature. Rheology samples were extruded into an adhesive film approximately 1 mm thick between silicone release liners. After cooling back to room temperature, films were then punched out with an 8-mm circular die, removed from the release liner, centered between 8 mm diameter parallel plates of the rheometer, and compressed until the edges of the sample were uniform with the edges of the top and bottom plates. Samples were run an under axial force control of 25 grams with sensitivity of ±30 grams and conditioned at the start temperature of 80° C. for 120 seconds prior to starting the test. The temperature was then ramped from 80° C. to 220° C. at 3° C. per minute while the parallel plates were oscillated at an angular frequency of 1 hertz and constant strain of five percent. While many physical parameters of the material were recorded during the temperature ramp, shear storage modulus (G′), shear loss modulus (G″), and tan delta were of primary importance in the characterization of the copolymers of this invention. The glass transition temperature, T_{g}, of the adhesive hard segment was measured by first determining its storage (G′) and loss shear (G″) moduli. The ratio of G″/G′, a unitless parameter typically denoted “tan delta”, was plotted versus temperature. The maximum point (point where the slope is zero) in the transition region between the rubbery plateau region and the terminal viscous region of the tan delta curve, if well defined, determines the T_{g} of the adhesive hard segment at that particular frequency.

### Examples 1-11 (EX1-EX11) and Comparative Examples 1 and 2 (CE1 and CE2)

Core-sheath filaments were made by co-extruding a non-tacky outer sheath layer around an inner PSA core, with the example compositions represented in Table 2 in weight percent (wt %). For all samples, the PSA core was compounded at 200 rotations per minute using an 18-millimeter co-rotating twin screw extruder (available from Coperian GmbH (Stuttgart, Germany)) with all zones heated between 160° C. and 170° C. After the PSA core was compounded, the melt stream was metered using a 3 cc/rev gear-pump (available from Colfax Corporation (Annapolis Junction, MD. United States)). The non-tacky outer sheath was melted and extruded using a 19.1-millimeter single screw extruder (HAAKE brand, available from Thermo Fisher Scientific (Waltham, MA, United States)). Both melt streams were fed into a co-axial die having a ˜3.50 millimeters exit diameter, which is described in U.S. Pat. No. 7,773,834 (Ouderkirk et al). The PSA was fed into the inner core layer of the coaxial die, while the non-tacky sheath material was fed into the outer sheath of the die; ultimately producing a core-sheath filament. The filament was drawn to either 6 or 12 millimeters final diameter through a water bath at room temperature (22° C.). The filaments were wound onto 75-millimeter diameter tubes for storage. Samples were created for adhesive testing to EPDM and clear coats. These filaments were further processed until mixed homogeneously by feeding them into a heated 40 mm TSE, pumped out with a gear pump at 180° C., through a 15.2 cm (6 inch) film die and deposited on a silicone treated PET liner. This was wound up on a 7.6 cm (3 inch) diameter core. For adhesive testing of examples on ribbed LSE plastic and headliner materials, the examples filaments were fed into a heated 40 mm TSE, pumped out with a gear pump at 180° C. through a 12.5 mm by 1 mm slot nozzle and dispensed molten directly onto substrates at a rate of 25.4 mm per second.

TABLE 2
Filament Sample Compositions (wt %)

| | | | | | | | | | | | | | | CB | |
|---|---|---|---|---|---|---|---|---|---|---|---|---|---|---|---|
| | D1161P | D1340 | D1113 | P1500 | LDPE | DK11 | P125 | P140 | HTG1 | SA90 | LBR-361 | NEVTACLT | I1010 | Pellets | 45/45/10 |
| EX1 | 35.0 | 10.0 | 0.0 | 0.0 | 4.0 | 0.0 | 0.0 | 28.0 | 4.0 | 8.0 | 6.0 | 0.0 | 1.5 | 0.5 | 3.0 |
| EX2 | 35.0 | 10.0 | 0.0 | 0.0 | 4.0 | 0.0 | 0.0 | 28.0 | 4.0 | 8.0 | 6.0 | 0.0 | 1.5 | 0.5 | 3.0 |
| EX3 | 19.0 | 10.0 | 0.0 | 16.0 | 4.0 | 0.0 | 0.0 | 28.0 | 4.0 | 8.0 | 6.0 | 0.0 | 1.5 | 0.5 | 3.0 |
| EX4 | 19.0 | 10.0 | 0.0 | 16.0 | 4.0 | 0.0 | 0.0 | 28.0 | 4.0 | 8.0 | 6.0 | 0.0 | 1.5 | 0.5 | 3.0 |
| EX5 | 11.0 | 12.0 | 24.0 | 0.0 | 4.0 | 0.0 | 0.0 | 30.0 | 0.0 | 8.0 | 6.0 | 0.0 | 1.5 | 0.5 | 3.0 |
| EX6 | 37.0 | 10.0 | 0.0 | 0.0 | 4.0 | 0.0 | 0.0 | 30.0 | 0.0 | 8.0 | 6.0 | 0.0 | 1.5 | 0.5 | 3.0 |
| EX7 | 29.0 | 10.0 | 8.0 | 0.0 | 4.0 | 0.0 | 30.0 | 0.0 | 0.0 | 8.0 | 0.0 | 6.0 | 1.5 | 0.5 | 3.0 |
| EX8 | 21.0 | 10.0 | 11.0 | 0.0 | 0.0 | 4.0 | 0.0 | 28.0 | 10.0 | 8.0 | 3.0 | 0.0 | 1.5 | 0.5 | 3.0 |
| EX9 | 10.0 | 6.0 | 28.0 | 0.0 | 0.0 | 4.0 | 0.0 | 30.0 | 5.0 | 6.0 | 6.0 | 0.0 | 1.5 | 0.5 | 3.0 |
| EX10 | 35.0 | 10.0 | 0.0 | 0.0 | 4.0 | 0.0 | 0.0 | 28.0 | 4.0 | 8.0 | 6.0 | 0.0 | 1.5 | 0.5 | 3.0 |
| EX11 | 35.0 | 10.0 | 0.0 | 0.0 | 4.0 | 0.0 | 0.0 | 28.0 | 4.0 | 8.0 | 6.0 | 0.0 | 1.5 | 0.5 | 3.0 |

T-Peel and 90° Peel Strength testing was conducted with the EPDM selected as the substrate. Results are represented in Tables 3 and 4. The performance of PT1100 (CE1) and EX4011 (CE2) were also tested as comparative examples. Dynamic Mechanical Analysis Testing was also conducted. Results are represented in Table 5.

TABLE 3
EPDM-to-EPDM T-Peel Testing Results

| | Avg. Load |
|---|---|
| | N/cm |
| Example | (lbf/in) |
| CE1 | 1.05 |
| | (0.6) |
| EX1 | 49.2 |
| | (28.1) |
| EX2 | 22.9 |
| | (13.1) |
| EX3 | 55.2 |
| | (31.5) |
| EX4 | 24.7 |
| | (14.1) |
| EX5 | 31.8 |
| | (18.2) |
| EX6 | 24.3 |
| | (13.9) |
| EX7 | 45.4 |
| | (25.9) |
| EX8 | 29.6 |
| | (16.9) |
| EX9 | 14.5 |
| | ( 8.3) |
| EX10 | 49.0 |
| | (28.0) |
| EX11 | 24.9 |
| | (14.2) |

TABLE 4
EPDM-to-Aluminum or RK8211 90° Peel Strength Testing Results

| | Al Panel | | | RK8211 Panel |
|---|---|---|---|---|
| | Avg. | Al Panel with 4298UV | RK8211 Panel | with 4298UV |
| | Load | Avg. Load | Avg. Load | Avg. Load |
| | N/cm | N/cm | N/cm | N/cm |
| | (lbf/in) | (lbf/in) | (lbf/in) | (lbf/in) |
| CE1 | 5.1 | 31.1 | 3.2 | 26.5 |
| | (2.9) | (17.8) | (1.8) | (15.1) |
| CE2 | 28.1 | 30.3 | 31.3 | N/A |
| | (16.0) | (17.3) | (17.9) | (N/A) |
| EX7 | 43.5 | 49.0 | 35.2 | 23.0 |
| | (24.9) | (28.0) | (20.1) | (13.2) |
| EX8 | 32.3 | 49.6 | 39.3 | 38.7 |
| | (18.4) | (28.3) | (22.4) | (22.1) |
| EX9 | 30.1 | 48.7 | 28.7 | 25.5 |
| | (17.2) | (27.8) | (16.4) | (14.5) |
| EX10 | 38.6 | 46.7 | 39.3 | 40.9 |
| | (22.0) | (26.7) | (22.5) | (23.4) |

TABLE 5
DMA Test Results

| | Hard | Local tan δ | |
|---|---|---|---|
| | Segment T_{g} | Minimum | |
| Example | (° C.) | (° C.) | 220° C. tan δ |
| EX1 | 165 | 190 | 1.24 |
| EX2 | 169 | 200 | 0.93 |
| EX3 | 162 | 190 | 1.20 |
| EX4 | 161 | 192 | 1.10 |
| EX5 | 165 | 194 | 0.88 |
| EX7 | 162 | 194 | 0.99 |
| EX8 | 158 | 201 | 0.98 |
| EX9 | 155 | 180 | 1.94 |
| EX10 | 162 | 198 | 0.93 |

### Examples 12-13 (EX12-EX 13) and Comparative Example 3 (CE3)

90° Peel Strength Testing was conducted on ribbed thermoplastic-polyolefin (TPO) obtained from Chrysler of Auburn Hills, MI. United States. Ribbed test coupons were 40 mm wide and 153 mm long. The ribs extended 5 mm above a 3 mm solid base. The rib tips were rounded, and the ribs were tapered, being 8 mm wide at the base and 6 mm wide at the top. The ribs ran the length of the coupon with a center-to-center spacing of 2 mm. Sixteen ribs spanned the central 30 mm of the coupon. A 1.27 cm (0.5 inch) wide samples either with a 0.89 mm (35 mil) adhesive layer placed directly on the ribs and subsequently heated to 190° C. for five minutes (EX12) or dispensed directly onto a ribbed part (EX13). Results are represented in Table 6. 5074 (CE3) was placed on ribbed TPO after it was primed with 4298UV. The adhesive compositions of EX12 and EX13 were identical to EX1.

TABLE 6
Ribbed TPO 90° Peel Strength Test Results

| | Avg. Load |
|---|---|
| | N/cm |
| Example | (lbf/in) |
| CE3 | 11.9 |
| | (6.8) |
| EX12 | 20.1 |
| | (11.5) |
| EX13 | 30.6 |
| | (17.5) |

### Example 14 (EX14) and Comparative Examples 9 and 10 (CE9 and CE10)

The core sheath filament of composition EX1 was converted to film via a heated 40 mm TSE, pumped out with a gear pump at 180° C. through a 15.2 cm (6 inch) film die and deposited on a silicone treated PET liner. Converted film adhesive was cut to the shape of a C520 (obtained from Ford Motor Company of Dearborn, MI. United States) windshield sensor bracket. The C520 was a glass filled polybutylene terephthalate (PBT) windshield bracket. It had a polygonal shape with 162 millimeters on the longest length and 160 millimeters on the shortest width with approximately 150 cm² of surface coverage. It (EX14) was adhered to the back of the bracket and then the bracket was placed in an oven at 180° C. After five minutes, the bracket was removed and pressed onto a piece of warmed, non-pretreated, laminated glass. The sample was allowed to dwell for 24 hours prior to evenly hanging 6 kg of weights. The glass-bracket assembly was hung such that the glass surface was parallel to the ground. No failure was seen up to 40 days.

PT1100 (CE9) and EX4011 (CE10) were placed on the backside of the C520 brackets and placed in a 65° C. 80% relative humidity (RH) oven with a load of 6 kg. There was no surface pre-treatment on the bracket. The samples were allowed to dwell for 24 hours prior to hanging. Both tapes were unable to hold the bracket for longer than one day.

### Example 15 (EX15) and Comparative Examples 11-13 (CE11-CE13)

The core sheath filament of composition EX1 was converted to film via a heated 40 mm TSE, pumped out with a gear pump at 180° C. through a 15.2 cm (6 inch) film die and deposited on a silicone treated PET liner. Converted film adhesive was cut to the shape of a 25.4 mm by 25.4 mm by 0.9 mm. The test standard followed was ASTM D3654, with minor modification. Four representative headliners were selected, each having a fibrous non-woven B-side (non-showing surface). The headliners consisted of light weight composite structures of various proprietary compositions that are typical for the automotive industry. Headliner materials were cut into 150 mm by 100 mm coupons for testing. The adhesive squares were placed on the B-side of a headliner material and these were placed between two hot plates without fully closing at 176.7° C. (350° F.) for three minutes. Upon immediate removal, an aluminum sheet was pressed onto the exposed adhesive. An aluminum ribbon was looped and stapled on the opposite end. The samples were hung in an 80° C. oven with a 500-gram weight and allowed to dwell. The amount of time that the samples held the 500-gram was recorded. The performance of three representative comparable adhesives: 5074 (CE11), 6111T (CE12), and 3794 (CE13) were also tested as comparative examples. Results are represented in Table 7.

TABLE 7
Static Shear Test Results

| | Headliner C | Headliner D |
|---|---|---|
| | (Minutes) | (Minutes) |
| CE11 | 28 | 45 |
| CE12 | 8000 | 8000 |
| CE13 | 1 | 1 |
| EX15 | 8000 | 8000 |

90° Peel Strength testing was conducted on EX15 and CE11, CE12, and CE13. The core sheath filament of composition EX1 was dispensed directly onto the headliner coupons. A thin 0.25 mm (10 mil) Al ribbon 16 mm wide and 150 mm long was placed on the adhesive and manually rolled down with a rubber roller using hand pressure. The performance of 3794 (CE11), 5074 (CE12) and 6111T (CE13) were also tested as comparative examples. Results are represented in Table 8.

TABLE 8
Headliner 90° Peel Strength Test Results

| | Headliner A | Headliner B | Headliner C | Headliner D |
|---|---|---|---|---|
| | Avg. Load | Avg. Load | Avg. Load | Avg. Load |
| | N/cm | N/cm | N/cm | N/cm |
| Example | (lbf/in) | (lbf/in) | (lbf/in) | (lbf/in) |
| CE11 | 0.90 | 0.56 | 0.77 | 1.0 |
| | (0.51) | (0.32) | (0.44) | (0.57) |
| CE12 | Not tested | Not tested | 2.97 | 2.19 |
| | | | (1.7) | (1.25) |
| CE13 | Not tested | Not tested | 1.75 | 4.2 |
| | | | (1.0) | 2.4) |
| EX15 | 2.33 | 1.27 | 1.93 | 2.1 |
| | (1.33) | (0.73) | (1.1) | (1.2) |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A method of bonding a pressure-sensitive adhesive to a substrate, the method comprising:
heating a styrenic block copolymer composition to provide an adhesive melt composition, wherein the styrenic block copolymer composition contains a hard segment block with a glass transition temperature of from 90° C. to 220° C.;
masticating the adhesive melt composition;
delivering the adhesive melt composition onto the substrate at a temperature that exceeds the glass transition temperature of the hard segment block by from 20° C. to 150° C., wherein the substrate is a non-film substrate; and
cooling the adhesive melt composition to obtain a bonded pressure-sensitive adhesive.

2. The method of claim 1, wherein the styrenic block copolymer composition is provided in a core-sheath filament comprising a styrenic block copolymer core and a sheath that is non-tacky at ambient temperature.

3. A method of bonding a pressure-sensitive adhesive to a substrate, the method comprising:
heating a styrenic block copolymer composition to provide an adhesive melt composition, wherein the styrenic block copolymer composition contains a hard segment block with a glass transition temperature of from 90° C. to 220° C., the styrenic block copolymer composition being provided in a core-sheath filament comprising a styrenic block copolymer core and a sheath that is non-tacky at ambient temperature;
masticating the adhesive melt composition;
delivering the adhesive melt composition onto the substrate at a temperature that exceeds the glass transition temperature of the hard segment block by from 20° C. to 150° C.; and
cooling the adhesive melt composition to obtain a bonded pressure-sensitive adhesive.

4. The method of claim 3, wherein the substrate is a non-film substrate.

5. The method of claim 1, wherein the styrenic block copolymer composition comprises one or more tackifiers.

6. The method of claim 2, wherein the core-sheath filament is delivered by a dispensing head comprising:
a barrel including one or more heating elements;
an inlet extending through a side of the barrel for receiving the core-sheath filament, the inlet including a beveled nip point to prevent breakage of the core-sheath filament as it is drawn into the barrel;
an outlet at a distal end of the barrel for dispensing the adhesive melt composition; and
a rotatable screw received in the barrel, the rotatable screw including at least one mixing element to masticate the adhesive melt composition.

7. The method of claim 1, wherein the substrate comprises one or more cavities, and wherein the adhesive melt composition upon delivery at least partially fills the one or more cavities.

8. The method of claim 7, wherein the substrate further comprises a plurality of ribs extending across the one or more cavities and wherein the adhesive melt composition upon delivery at least partially fills spaces between the plurality of ribs.

9. The method of claim 1, wherein the substrate comprises a low-surface-energy substrate having a surface energy of from 20 mJ/m² to 37 mJ/m².

10. The method of claim 9, wherein the low-surface-energy substrate comprises a thermoplastic olefin.

11. The method of claim 9, wherein the low-surface-energy substrate is unprimed, and is neither surface-treated nor cleaned prior to delivering the adhesive melt composition.

12. The method of claim 1, wherein the substrate comprises a porous substrate.

13. The method of claim 1, wherein the adhesive melt composition is shaped as it is being delivered or cooled, the adhesive melt composition being shaped either by profile extrusion or by molding against a release surface disposed on the substrate.

14. A method of bonding a pressure-sensitive adhesive to a substrate, the method comprising:
heating a styrenic block copolymer composition to provide an adhesive melt composition, wherein the styrenic block copolymer composition contains a hard segment block with a glass transition temperature of from 90° C. to 220° C.;
masticating the adhesive melt composition;
delivering the adhesive melt composition onto the substrate at a temperature that exceeds the glass transition temperature of the hard segment block by from 20° C. to 150° C., wherein the substrate comprises a release surface; and
cooling the adhesive melt composition to obtain a bonded pressure-sensitive adhesive.

15. A bonded assembly made using the method of claim 1.
